(19) United States
(12) Patent Application Publication
(10) Pub. No.: US 2022/0016703 A1
(43) Pub. Date: Jan. 20, 2022

(54) COMPACT DEVICE AND PROCESS FOR THE PRODUCTION OF NANOPARTICLES IN SUSPENSION

(71) Applicant: Universität Duisburg-Essen, Essen (DE)

(72) Inventors: Stephan Barcikowski, Essen (DE); Marcus Lau, Essen (DE); Friedrich Waag, Essen (DE)

(21) Appl. No.: 17/281,674

(22) PCT Filed: Oct. 1, 2019
(86) PCT No.: PCT/EP2019/076618

§ 371 Date: Mar. 31, 2021

(30) Foreign Application Priority Data
Oct. 1, 2018 (DE) 10 2018 216 824.5

(51) Int. Cl. B22F 9/04; B22F 1/00; B23K 26/0622; B23K 26/12

(52) U.S. Cl. CPC B22F 9/04; B22F 1/0022; B23K 26/082; B23K 26/127; B23K 26/0624

(57) ABSTRACT

The invention shows a device for producing nanoparticles, the device having a pulsed laser with a scanning device for guiding the beam of the laser over a target that is fixed in a flow-through chamber. The flow-through chamber is reversibly connected to a supply line for carrier fluid, so that the flow-through chamber is exchangeable e.g. for a further flow-through chamber having a different target and/or a different dimensioning.

The present invention relates to a compact device for the production of nanoparticles, e.g. from a metal or a metal alloy, a metal oxide or a mixture of at least two metal oxides, at least one carbide, at least one nitride, or mixtures of at least two of these, a carbon-based and/or a hydrocarbon-based solid, in particular from metal (Me⁰), and to a process for the production of nanoparticles suspended in a carrier liquid, in particular while making use the device. The device comprises a pulsed laser, the beam of which is directed onto a target and can be moved over the target, e.g. by means of a scanning device, wherein the target is mounted in a flow-through chamber which opposite the target has a wall section that is transparent to the laser beam. The device and process have the advantage that the laser can be configured to emit a low power.

### STATE OF THE ART

EP 2 735 390 A1 describes a device in which a free jet is generated from a suspension of metal particles, which free jet is irradiated with a laser.

For the detection of cyanide, US2011/303050 A1 describes the production of zinc oxide nanoparticles, which serve as electrode coating, by pulsed laser irradiation of a target of pure zinc that is statically arranged in aqueous 1-10% hydrogen peroxide.

WO 2010/007117 A1 describes the production of gold nanoparticles by pulsed laser irradiation of a gold target that is arranged in a carrier liquid, which laser irradiation is moved over the target.

### OBJECT OF THE INVENTION

The invention has the object to provide an alternative device and an alternative process for the production of suspended nanoparticles that can be carried out thereby, wherein the device preferably has a laser having a low power and/or the target can be exchanged in a simple, process-safe and work-safe manner and can be locked in a geometrically defined manner in front of the laser beam. The device should be compactly constructed and contained in a housing.

### DESCRIPTION OF THE INVENTION

The invention achieves the object by the features of the claims and in particular by a device for the production of nanoparticles, the device comprising a pulsed laser having a scanning device that is configured to guide the beam of the laser over a target which is fixed in a flow-through chamber. The scanning device can be arranged in the beam path of the laser, e.g. in the form of at least two mirrors or wedge plates that can be moved in a controlled manner, or the scanning device can be configured to itself move the laser in a controlled manner relative to a flow-through chamber or resp. relative to the housing. The flow-through chamber is to be connected detachably to a supply line for carrier fluid, so that the flow-through chamber is exchangeable, e.g. for another flow-through chamber having a different target and/or a different dimensioning. The laser, the flow-through chamber, a supply line for carrier fluid and the scanning device as well as a conveying device arranged in the supply line and/or a control unit for the laser and/or a control unit for the scanning device and/or a control unit for the conveying device, preferably also a reservoir for carrier fluid, are components of the device and are further preferably arranged in a common housing which is light-tight for laser radiation of the laser.

The scanning device is preferably configured to guide the laser beam over the target at a speed of 0.1 to 10 m/s.

In this way, effective ablation of the target is achieved, since the laser pulses each hit the target outside of a cavitation bubble generated by the preceding laser pulse, but still hit the target in the zone that is thermally influenced by the preceding laser pulse. In this thermally influenced zone, the thermal energy level of the target is higher than in regions further away from the location hit by a previous laser pulse.

Preferably, a focusing optics is arranged in the beam path between the scanning device and the target in order to focus the laser beam onto the target. The focusing optics may have a focal length between 20 and 200 mm, preferably a focal length in the range of 50 to 100 mm (each inclusive). Preferably, the focusing optics is arranged to produce a fluence in the range of 0.5 to 10 J/cm² on the target, preferably a fluence in the range of 2 to 6 J/cm². It has shown that a fluence in the range of 2 to 6 J/cm² results in an efficiency maximum for ablation.

Further preferably, a telescope is arranged in the beam path upstream of the scanning device, e.g. between the laser and the scanning device, in order to expand the laser beam. This has the advantage that mirrors in the scanning device are damaged less quickly. Moreover, a laser beam having a larger diameter can better be focused to smaller diameters. For this reason, preferably a telescope is arranged in the beam path in front of the scanning device, and a focusing unit in the beam path after the telescope, in particular after the scanning device.

Preferably, the laser and the scanning device, preferably optionally the focusing unit and the optional telescope, are configured such that the laser beam can only hit the flow-through chamber, or resp. only hit the insert in which the flow-through chamber is contained. For this, the scanning device can be limited in its deflection so that the laser beam can only be directed at the flow-through chamber or only at the insert, e.g. by stops that can be fixed to the housing of the device or to the insert.

The target is e.g. a metal, preferably an alloyed or pure metal of oxidation state 0 (Me⁰), e.g. gold, a metal of the platinum group, or an alloy of at least two of these. The metal, which may be present in the oxidation state 0 or as an oxide, carbide, or nitride, can e.g. be gold, silver, copper, platinum, palladium, nickel, iron, cobalt, manganese, titanium, aluminum, tin, zinc, or a mixture of at least two of these.

The target is attached to a wall of a flow-through chamber inside the flow-through chamber, e.g. fixed on the wall or fixed in a recess of the wall, e.g. fixed with positive fit and/or non-positive fit. Opposite the target, the flow-through chamber has a radiation-transparent wall section which is preferably planar and further preferably parallel to the surface of the target facing this wall section. Therein, the target e.g. has a planar surface facing the radiation-transparent wall section, and the radiation-transparent wall section is parallel thereto and has a constant wall thickness. The radiation-transparent wall section is at least as large as the surface of the target facing it, and preferably exactly as large, so as to be able to completely scan the surface of the target with the laser beam.

Preferably, the target is arranged at a distance of 2 to 5 mm from the inside of the radiation-transparent wall section.

The side walls of the flow-through chamber, which connect the radiation-transparent wall section and the opposite wall on which the target is mounted, may be perpendicular to these two walls, convex or concave to the inner volume of the flow-through chamber. Preferably, the flow-through chamber has a distance of 2 to 5 mm, which distance is filled by the carrier liquid during the process, between the target and the radiation-transparent wall section, which wall section is preferably parallel to the target. Further preferably, the side walls of the flow-through chamber are longer by a factor of at least 1 to 2, e.g. rectangular or arranged as an oval. Inlet and outlet for carrier fluid are arranged on opposite side walls.

The target can have edges standing rectangular to one another which enclose a surface facing the laser beam, e.g. having edge lengths in the range of 1 to 10 mm each, wherein preferably the longer edge is arranged in parallel to the flow direction of the flow-through chamber. The edge lengths may e.g. have a ratio in the range of 1:2 to 1:5. The surface enclosed by the edges is arranged at an angle of about 90° or at an angle less than 90° to the laser beam. Preferably, this surface of the target to which the laser beam is directed or which is scanned by the laser beam is arranged at an angle less than 90°, e.g. at an angle sufficient to deflect reflections by at least half the diameter of the laser beam. The angle of the surface of the target facing the laser beam can be, for example, 88 to 89.5° to the laser beam. This deviation of the target surface from the perpendicular to the laser beam avoids reflections from the target into the beam path of the laser. Further preferably, the target has a thickness in the range of 0.2 to 2 mm, which further preferably is constant over the entire target.

The device has one or more reservoirs for carrier liquids, e.g. a capacity of 0.5 to 10 L each, e.g. 1 to 5 L, which is or are connected to the flow-through chamber by means of a supply line. A controllable multi-port valve that is arranged in a supply line allows opening of the supply line to the desired supply container in the case of several supply containers. A conveying device which is preferably configured to set a flow velocity of 1 to 10 mm/s, preferably 4 to 5 mm/s of the carrier liquid in the flow-through chamber, is arranged in the supply line. The conveying device may be a controlled pump and/or a controlled valve, wherein the pump may be formed by a pressure source, e.g. a pressurized gas cylinder, which pressurizes the reservoir. The pump, e.g. a pressure source, and/or the valve may be controlled by manual adjustability. Optionally, the control for the conveying device for generating a preselected flow velocity may be permanently set or may be set to a value in dependence on a code which is connected to the flow-through chamber, e.g. attached to an insert containing the flow-through chamber.

A carrier fluid can be at least one organic solvent, e.g. an aliphatic alcohol or a ketone, water, preferably deionized or distilled, or a mixture of at least two of these, optionally with at least one dissolved or dispersed additive, e.g. an oxidizing or reducing agent, inorganic and/or organic salt, e.g. ammonium hydroxide, sodium chloride, sodium phosphate buffer, carbonate buffer, tetraethylammonium hydroxide, citrate, optionally an organic colloid stabilizer, e.g. surfactants, polymers, esters, and mixtures of at least two of these.

The flow-through chamber consists of materials which are stable to corrosion by one of the carrier fluids, and in particular does not release ions or molecules into the carrier fluid. For example, the flow-through chamber consists of plastic, glass, and/or passivated metal.

Generally preferably, the supply line is connectable to an inlet of the flow-through chamber, which inlet is located below the flow-through chamber, optionally below the outlet of the flow-through chamber, wherein e.g. the cross-section of the flow channel is arranged at an angle of at maximum 45° or at maximum 30°, preferably at maximum 10° to the horizontal, in particular in parallel to the horizontal. In this way, gas bubbles can leave the flow-through chamber more easily with the carrier liquid. The drain line connecting the flow-through chamber to the outlet is preferably directed downward at an angle of from horizontal to vertical in the section leading to the outlet, wherein a collecting container having a volume of, for example, 0.01 to 5 L, for example 0.05 to 0.5 L is arranged at the outlet.

Preferably, the laser has a power of from 0.2 to 30 W, e.g. from 0.5 to 5 W, and is further preferably configured to emit laser pulses of an energy of from 10 to 1000 μJ with a fluence of from 0.1 to 10 J/cm², preferably at a repetition rate of from 500 to 5000 Hz at a pulse duration of from 0.01 to 10 ns, e.g. from 0.01 or 0.5 ns to 1 or to 10 ns. Preferably, the laser is configured to emit a wavelength in the range from 200 to 1500 nm, e.g. from 350 or 400 nm to 1100 nm, e.g. 355, 515, 532, 1030, or 1064 nm. The laser may have a repetition rate of 500 to 5000 Hz, e.g., 1200 to 2700 Hz. It has shown that such a laser, in conjunction with the scanning device and the flow-through chamber, has a power sufficient for laser ablation of the target to suspended nanoparticles. Generally preferably, the power of the laser is its average maximum power. Such a laser has a significantly higher efficiency, expressed as energy-specific productivity, in the production of nanoparticles, in relation to e.g. a laser having a power of about 10 W with a pulse duration of 5000 to 10 000 ps, a repetition rate of 20 to 200 kHz, or to a laser of an average maximum power of 500 W with a pulse duration of 3 ps and a repetition rate of 1.2 to 40.5 MHz at about the same wavelength. Such a laser preferably is a diode-pumped single-mode laser and in particular is a microchip laser.

Generally, the laser can have heat sinks as a cooling device with only ambient air flowing around them, and optionally a fan can be included in the housing. Preferably, the device does not have an active cooling device for the laser and/or an active cooling device that supplies a pre-cooled cooling medium for the flow-through chamber, in particular supplies no cooling liquid, e.g. no cooling water.

The flow-through chamber with the target fixed therein is contained in an insert which can be connected reversibly to the housing of the device, so that the flow-through chamber is to be connected reversibly at its inlet to the supply line for carrier fluid. The insert can e.g. be inserted into a socket on the housing, e.g. into a matching recess of the housing, and can be fixed to the housing, e.g. clamped, latched or screwed. Therein, after insertion of the insert into the socket the flow-through chamber is reversibly connectable to the supply line, and the flow-through chamber is arranged in the housing in a position in which the scanning device can direct the laser beam through the radiation-transparent wall section and onto the target.

Optionally, a sensor is functionally coupled to the flow-through chamber, which sensor records a signal for operation of the laser when the target has a thickness that is too thin for ablation or has holes. Such a sensor may be a radiation sensor and/or a temperature sensor directed from the outside towards the section of the wall of the flow-through chamber on which the target is arranged inside the flow-through chamber, wherein the sensor is configured to transmit a signal to a control unit of the laser for turning the laser off when radiation emitted by the laser is recorded or when a temperature above a predetermined value is recorded. If the sensor is formed by a radiation sensor, e.g. a photocell, the wall of the flow-through chamber that abuts the target preferably is at least partially optically transparent to the laser radiation, and optionally is scattering in order to direct laser light onto a radiation sensor. A radiation sensor may be arranged at a distance from the flow-through chamber. The wall of the flow-through chamber, on the inner side of which the target is arranged, and/or the radiation-transparent wall section may be made of e.g. polycarbonate, polyethylene terephthalate, polypropylene, and/or polyethylene, preferably glass, e.g. BK7 glass, quartz glass. Preferably, the radiation-transparent wall section on its outer surface, optionally additionally on its inner surface, has an anti-reflection coating for the radiation of the laser.

Optionally, the flow-through chamber including its radiation-transparent wall section can generally be formed single-pieced, e.g., from one or a mixture of at least two of the aforementioned plastics. Further optionally, a diffusing panel and/or a converging lens may be arranged between the radiation sensor and the flow-through chamber.

Optionally, the wall of the flow-through chamber against which the target lies, or the wall opposite the radiation-transparent wall section, is transparent to the radiation from the laser, e.g. this wall can also form a radiation-transparent wall section.

The sensor can be mounted on the insert, and the insert can have electrical contacts which are mounted matching with contacts of the socket which receive the signal of the sensor and conduct it to a control unit, e.g. to the control unit of the laser or of the scanning device. Alternatively, the sensor may be located on the housing.

If the sensor is formed by a temperature sensor, it is preferably thermally conductively connected to the wall section of the flow-through chamber, optionally with a thermal conductor directly connecting the temperature sensor to the wall section of the flow-through chamber. Such a thermal conductor can e.g. be a metal plate.

Alternatively or additionally, the sensor may be a turbidity sensor which is connectable to the outlet of the flow-through chamber, e.g. is attached to a drain line connected to the outlet of the flow-through chamber. A turbidity sensor is configured to sense turbidity in the drain line and may e.g. be formed by an emitting diode and a photocell spaced apart by the cross-section of the drain line. A turbidity sensor is connected to a control unit for the laser, which control unit is configured to turn off the laser after recording readings for the turbidity that indicate a malfunction of the laser or resp. the lack of production of nanoparticles from the target, in particular when the laser is powered to indicate a turbidity which is below a predetermined turbidity that occurs e.g. upon ablation of nanoparticles from the target by the laser.

Optionally, the device may be configured to add up the duration of the signal from the turbidity sensor if this is above the turbidity of the carrier liquid, preferably is at the predetermined turbidity that is reached upon ablation of nanoparticles from the target.

Alternatively or additionally, the sensor can be a sound sensor which is arranged at a distance from the flow-through chamber, e.g. on the housing, or which is in contact with the inner volume of the flow-through chamber and is configured to record the duration and amplitude for predetermined frequencies and/or to send a control signal for switching off the laser to the control unit of the laser when reaching a predetermined total duration and/or upon recording of a predetermined amplitude and/or a predetermined frequency. Such a sound sensor has e.g. a sensitivity in the range of 1 to 100 kHz, preferably 5 to 20 kHz. For example, a sound sensor is in contact with the inner volume of the flow-through chamber and can be attached to a wall of the flow-through chamber or to a supply line or drain line connected to the flow-through chamber. Therein, the device may be set up to add up the duration of the signal from the sound sensor for at least one predetermined frequency. The device can alternatively or additionally be configured so that the sound sensor when recording a predetermined frequency sends a signal for switching off the laser to its control unit, in particular when simultaneously operating the laser when this frequency is recorded. Such a frequency can be predetermined for the device e.g. for a flow-through chamber for the case in which the target falls below a minimum thickness or in which no target is arranged, or predetermined for the device for the case when the laser is in operation and hits the insert outside of the radiation-transparent insert. It has shown that the frequency generated when the target is irradiated by the laser does not change significantly over the duration of the ablation. Therefore, it is preferred that a sound sensor is connected to a device for detecting and adding up the signal, and that the device is configured to switch off the laser when a maximum total duration of laser operation is reached.

Therein, the device can be configured to compare this added-up signal from the sensor, e.g. of the turbidity sensor or of a sound sensor, with a predetermined maximum total duration for operation of the laser and to switch off the laser when reaching the maximum total duration for laser operation.

The predetermined maximum total duration for operation of the laser is, for example, one that is predetermined for a flow-through chamber with the target arranged therein. Therein, the predetermined total duration may be contained in a coding which is attached to the insert. Generally preferably, the insert has a coding, and a reading unit for reading out the coding is attached to the socket on the housing on which the insert is to be arranged, wherein the reading unit is configured to send a specific control signal to the control unit of the laser and/or to the control unit of the scanning device and/or to the control unit of the conveyor device, depending on the coding read out. This coding and a control signal dependent thereon can comprise e.g. the predetermined total duration for the operation of the laser with the flow-through chamber of the insert, predetermined operating parameters for the laser and/or predetermined operating parameters for the control unit of the conveyor unit. The coding can be in the form of e.g. an optically readable code, a transponder, an electrically contactable circuit, or a mechanically scannable pattern.

The laser has a control unit that controls e.g. the power supply and an optional shutter arranged in the beam path of the laser. For the purposes of the invention, such a shutter can be used to turn off the laser, since it inactivates the laser beam even when power is applied to the laser.

Preferably, the housing comprises a switch, which is e.g. arranged on the socket, which is configured to change its switching position when the insert is fixed in the socket and which is configured to provide power supply to the laser only upon fixing the insert in the socket. Such a switch can e.g. be a pressure switch or a conductor section attached to the insert that interconnects spaced contacts of the socket, or can be an actuator that actuates a switch attached to the socket.

The housing, which is impervious to radiation from the laser, preferably has no external connections for gases or liquids, but only has a power supply, e.g. an electrical connection. The light-proofness, respectively the prevention of laser radiation leakage, is maintained by the insert containing the flow-through chamber, in the presence and absence of the insert, and also when reservoirs are used. Therein, the correct use of the supply container(s) is ensured by a switch based on the principle of the switch in FIG. 7. The laser is one of laser protection class 1.

Optionally, the device has a temperature sensor arranged at the inlet of the flow-through chamber, e.g. at the supply line, and further optionally a further temperature sensor at the outlet of the flow-through chamber, each for recording the temperature of the carrier liquid. The device can be configured to control the laser depending on a signal from one or both of these temperature sensors, in particular to switch off the laser if, after operation of the laser for a predetermined period of time, e.g. for a maximum of 5 s or for a maximum of 4 s, no increase of temperature is recorded by the sensor arranged at the outlet compared to the sensor arranged at the inlet.

The invention is now described in more detail with reference to the figures, which schematically show in

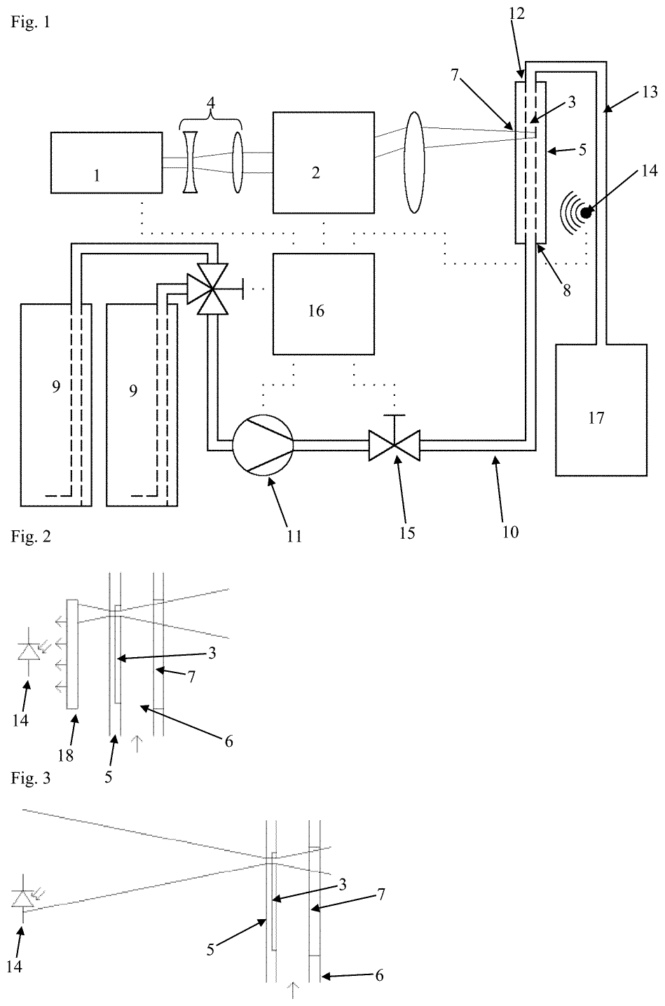

FIG. 1 a device according to the invention,

FIGS. 2 and 3 flow-through chambers having an optical sensor,

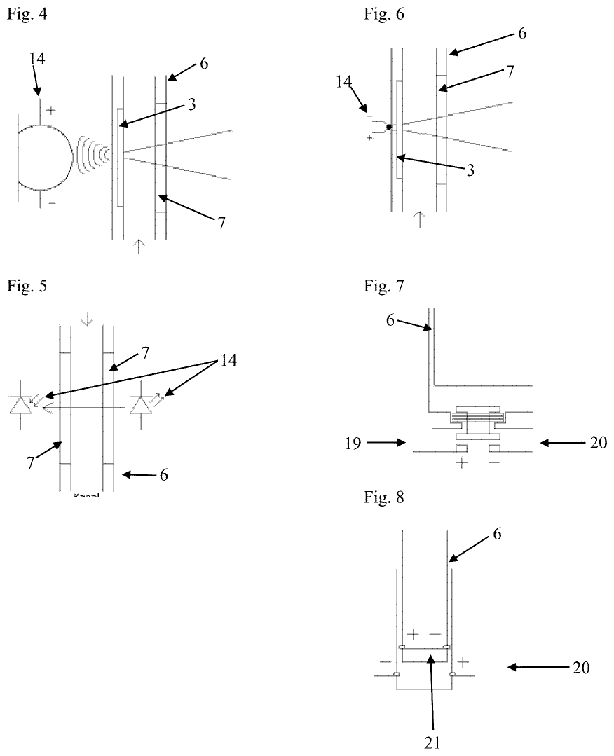

FIG. 4 a flow-through chamber having an acoustic sensor,

FIG. 5 a flow-through chamber having a turbidity sensor,

FIG. 6 a flow-through chamber having a temperature sensor, and in

FIGS. 7 and 8 embodiments of a switch at the insert.

FIG. 1 shows an overview of a device according to the invention having a pulsed laser 1, the beam of which by means of a scanning device 2 can be directed onto a target 3 and guided over the target 3. In the beam path between the laser 1 and the scanning device 2, a telescope 4 is arranged, as is preferred, which expands the laser beam to the scanning device. The target 3 is attached to a wall 5 of a flow-through chamber 6, which opposite the target 3 has a wall section 7 that is transparent to the laser beam. This radiation-transparent wall section 7 can be made of plastic or glass. As preferred, the flow-through chamber 6 is arranged with its cross-section approximately horizontally and its inlet 8 is located below the target 3, so that a carrier liquid flows through the flow-through chamber 6 from bottom to top and gas bubbles are discharged. The carrier fluid is guided from a reservoir 9 to the inlet of the flow-through chamber 6 via a supply line 10, in which a conveying device 11 is arranged, and exits from an outlet 12 arranged opposite the inlet 8, to which outlet 12 a drain line 13 is connected which discharges into a collecting vessel 17. The laser 1, the scanning device 2 for guiding its beam, the flow-through chamber 6, the conveying device 11 in the supply line 10, and sensors 14 are, as is preferred, arranged in a common housing which has no supply line for cooled cooling medium. The laser 1 can be cooled exclusively by cooling elements around which ambient air can flow, optionally reinforced by a fan.

The conveying device 11, which generally preferably comprises a flow meter, in the embodiment shown here is formed by a pump and a controlled valve 15, which is arranged in the supply line 10. Alternatively, the conveying device can be formed by pressurized gas being applied to the reservoir 9 for carrier liquid, e.g. from a pressurized gas cylinder, and in that a controlled valve 15 is arranged in the supply line 10.

A sensor 14, which is arranged at the flow-through chamber 6 and which in particular is directed to the wall 5 opposite the wall section 7 which is transparent to the laser radiation, is connected to a control unit 16 which is set up to control, depending on a signal from the sensor 14, the laser 1, the conveying device 11, and/or the scanning device 2.

FIG. 2 shows a flow-through chamber 6 in cross-section along the direction of flow of the carrier fluid, in which laser radiation passing through the radiation-transparent wall section 7 hits the target 3, or resp. in the absence of the target 3 passes through the wall 5 of the flow-through chamber 6 on which the target 3 was arranged and subsequently hits a sensor 14 formed as a radiation sensor. Between the flow-through chamber and the radiation sensor, a scattering disk 18, e.g. a frosted glass disk, is arranged which scatters laser radiation passing through the wall 5 of the flow-through chamber 6 onto the radiation sensor 14.

FIG. 3 shows, as an alternative to a scattering disk 18, the arrangement of the radiation sensor 14 at a sufficiently large distance from the flow-through chamber 6 so that laser radiation passing through can hit the sensor 14.

FIG. 4 shows a sensor 14 embodied as a sound sensor, which may be mounted at a distance from the flow-through chamber 6, e.g. on a housing. It has shown that the ablation of material from the target 3 during laser irradiation leads to characteristic vibrations, and the impingement of the laser beam directly onto the wall 5 of the flow-through chamber 6, in front of which the target 3 had been arranged, leads to changes in the vibrations.

FIG. 5 shows a setup for a turbidity sensor arranged as sensor 14 at the flow-through chamber 6, the signal of which sensor 14 is a measure for the concentration of nanoparticles produced. The turbidity sensor 14 may be formed by a light emitting diode and a photodiode arranged opposite at the flow-through chamber. In the embodiment of the sensor 14 as a turbidity sensor, preferably also the wall 5 that is opposite to the wall section that is transparent to the laser beam is transparent to the laser beam, e.g. this wall may be formed by an identical wall section 7 transparent to laser radiation.

FIG. 6, as sensor 14, shows a temperature sensor that is thermally coupled to the wall 5 of the flow-through chamber 6 to which the target 3 is attached, e.g. by means of a metal plate connecting the temperature sensor to the flow-through chamber 6. It has shown that upon irradiation of the target 3 by a laser, a significant increase of temperature can be measured after about 3 to 5 s on the outer surface of that wall 5 of the flow-through chamber 6 to which the target 3 is attached, so that the signal from a temperature sensor generates a signal for the impingement of the laser beam onto the target 3, and this signal can be passed to the control unit 16 of the laser 1, e.g. as a control signal.

FIG. 7 shows a section of an insert in which a flow-through chamber 6 may be arranged and which upon positioning in a socket 19 on the housing actuates a pressure switch 20. This switch 20 can e.g. switch-on the power supply to the laser 1 when the insert is correctly positioned in the socket 19, and/or generate a signal for the control unit 16 of the conveying device 11.

FIG. 8 shows an alternative switch 20 in which upon positioning the insert containing the flow-through chamber 6 in the socket on the housing, a conductor 21 on the insert closes an open current conductor 22 in order to generate a signal for the presence of the insert and/or to switch-on a line to the power supply.

The following table shows the result of a comparison of the production of gold nanoparticles by irradiating a gold target in water with different lasers, each of which produced a fluence of up to 20 J/cm². The laser that was used according to the invention was a diode-pumped microchip laser having an average maximum power of 0.15 W, for comparison a laser with about 10 W (medium class) and a laser with 500 W (high power class).

| | according to the | medium | high power |
|---|---|---|---|
| | invention | class | class |
| pulse duration (ps) | 1000 | 5000 | 3 |
| mean wattage (W) | 0.15 | 5 | 500 |
| M² | <1.4 | <1.5 | <1.2 |
| wavelength (nm) | 1064 | 1064 | 1030 |
| repetition rate (kHz) | 1.2 | 15 | 5000 |
| pulse energy (μJ) | 130 | 330 | 100 |
| Maximum of absorbed | 2.5 | 6.7 | 0.3 |
| fluence | | | |
| pulse distance (μm) | 8300 | 670 | 97 |
| productivity (μg/s) | 1.8 | 10.3 | 1660.7 |
| efficiency of | 43.1 | 7.1 | 12.4 |
| production (mg/Wh) | | | |

This comparative test makes it clear that the energy-specific efficiency is highest for the laser used in the process according to the invention, although this has the lowest power. The laser used in the process according to the invention shows an efficiency that is better by a factor of 6 than the medium-class laser and an efficiency that is better by a factor of 3.5 than the high power class laser. A further advantage of the process and device according to the invention results from the lower energy consumption for the laser and the lower costs for the laser.

### LIST OF REFERENCE SIGNS

1 laser
2 scanning device
3 target
4 telescope
5 wall
6 flow-through chamber
7 wall section transparent to laser radiation
8 inlet
9 reservoir
10 supply line
11 conveying device
12 outlet
13 drain line
14 sensor
15 valve
16 control unit
17 collection vessel
18 scattering disk
19 socket on housing
20 switch
21 conductor
22 open conductor

1. A device for the production of nanoparticles, comprising a pulsed laser, a scanning device to guide a beam of the laser, a flow-through chamber having a target support wall, a radiation-transparent wall opposite the target support wall, a supply line connected to at least one reservoir for carrier fluid and connected to the flow-through chamber, a controlled conveying device arranged in the supply line and configured to control a flow velocity of carrier fluid within the flow-through chamber in a range of 1 to 10 mm/s, wherein the laser has a maximum power of 5 W and is configured to emit pulses having a pulse energy of 0.01 to 10 mJ and a pulse duration of 0.5 to 10 ns with a repetition rate of 500 to 5000 Hz and a fluence of 0.1 to 10 J/cm².

2. The device according to claim 1, wherein the laser is configured to emit pulses having a pulse energy of 10 to 1000 μJ and a pulse duration of 0.5 to 1 ns with a repetition rate of 500 to 5000 Hz and a fluence of 0.1 to 10 J/cm².

3. The device according to claim 1, wherein a distance of the radiation-transparent wall section from a target supported by the target support wall is at maximum 5 mm.

4. The device according to claim 1, wherein the scanning device is configured to guide the laser beam at a speed of 0.1 to 10 m/s over a target supported by the target support wall.

5. The device according to claim 1, the conveying device comprising one or both of a controlled valve and a controlled pump.

6. The device according to claim 1, wherein the flow-through chamber is arranged with its cross-section at an angle of at maximum 30° to the horizontal.

7. The device according to claim 1, wherein the supply line is connected to an inlet of the flow-through chamber and the inlet is arranged below the flow-through chamber.

8. The device according to claim 1, comprising one or both of a radiation sensor and a temperature sensor configured to sense a target on the target support wall from outside the flow-through chamber and to transmit a signal for switching off the laser when radiation or a temperature above a predetermined value is recorded.

9. The device according to claim 1, wherein the flow-through chamber is reversibly connectable to the supply line and the flow-through chamber is contained in an insert which is reversibly fixable in a socket of a housing, wherein one or both of the scanning device and the laser are arranged in the housing.

10. The device according to claim 9, comprising a switch in the housing that changes its switching position upon fixation of the insert in the socket and enables power supply for the laser only upon fixation of the insert in the socket.

11. The device according to claim 9, wherein the housing is light-proof against radiation of the laser.

12. The device according to claim 1, comprising at least two reservoirs for carrier liquid connected to the supply line by a switchable multi-port valve.

13. The device according to claim 1, comprising a drain line connected to an outlet of the flow-through chamber, a turbidity sensor configured to record the turbidity in the drain line and connected to a control unit for the laser, the control unit being configured to switch off the laser after recording measurement values for presence of turbidity for a predetermined total duration.

14. The device according to claim 13, wherein the insert comprises a coding, a reading unit for reading out the coding is attached to the socket, and the reading unit is configured to send a specific control signal depending on the coding read out to the control unit.

15. The device according to claim 14, wherein the specific control signal is asserted for a predetermined maximum duration of operation of the laser.

16. The device according to claim 1, comprising one or both of a telescope arranged in a beam path of the laser before the scanning unit and a focusing unit arranged in the beam path after the scanning unit.

17. The device according to claim 1, comprising a sound sensor in contact with an inner volume and configured to record duration and amplitude for predetermined frequencies and to send a control signal for switching off the laser when one or both of a predetermined total duration and a predetermined amplitude are senses.

18. The device according to claim 1, comprising a controlled shutter arranged in a beam path of the laser.

19. A process for producing nanoparticles suspended in a carrier liquid, comprising irradiating a target with laser radiation which is guided over the target that is mounted in a flow-through chamber which has a radiation-transparent wall section opposite the target while the carrier liquid flows through the flow-through chamber, the carrier liquid being supplied from a reservoir through a supply line in which a controlled conveying device is arranged, wherein the conveying device controls the flow of the carrier liquid to a flow velocity of 1 to 10 mm/s through the flow-through chamber, and wherein the laser provides a maximum power of 5 W and emits pulses with a pulse energy of 0.01 to 10 mJ and a pulse duration of 0.5 to 10 ns with a repetition rate of 500 to 5000 Hz and a fluence of 0.1 to 10 J/cm².

20. The process according to claim 19, wherein the laser emits pulses with a pulse energy of 10 to 1000 μJ and a pulse duration of 0.5 to 1 ns with a repetition rate of 500 to 5000 Hz and a fluence of 0.1 to 10 J/cm².

21. The process according to claim 19, wherein a laser beam of the laser is guided at a speed of 0.1 to 10 m/s over the target in a controlled pattern by a scanning device.

22. The process according to claim 19, wherein one or both of a radiation sensor and a temperature sensor monitors the target from outside the flow-through chamber and recording one or both of radiation and a temperature above a predetermined value transmits a signal to switch off the laser.

23. The process according to claim 19, wherein the flow-through chamber is contained in an insert releasably fixed in a socket of the housing, and the flow-through chamber is releasably connected to the supply line, and the flow-through chamber is aligned to the scanning device and the laser.

24. The process according to claim 23, wherein the fixing of the insert in the socket influences the switching position of a switch and the switch establishes a power supply for the laser only in its switching position in which the insert is fixed in the socket.

25. The process according to claim 24, wherein a sound sensor in contact with the inner volume of the flow-through chamber records their duration and amplitude or predetermined frequencies and upon reaching a predetermined total duration and/or upon recording a predetermined amplitude sends a control signal for switching off the laser.

26. The process according to claim 25, wherein a drain line is connected to an outlet of the flow-through chamber and a turbidity sensor records turbidity in the drain line and, after recording readings for the presence of turbidity for a predetermined total duration, sends a signal for shutting down the laser.

27. The process according to claim 23, wherein the insert has a coding for the material and/or for the size of the target and/or for control signals for a control unit of the laser and/or for the conveying device, a reading unit for reading out the coding is attached to the socket, and the reading unit reads out the coding and sends a control signal dependent thereon to the control unit of the laser and/or to the control unit of the conveying device.
